(19) United States
(12) Patent Application Publication
(10) Pub. No.: US 2015/0142529 A1
(43) Pub. Date: May 21, 2015

(54) BUSINESS MANAGEMENT SYSTEM

(71) Applicant: KCCS MANAGEMENT CONSULTING, INC., Tokyo (JP)

(72) Inventors: Naoyuki Morita, Tokyo (JP); Katsumasa Aoki, Tokyo (JP)

(21) Appl. No.: 14/362,216

(22) PCT Filed: Mar. 19, 2014
(86) PCT No.: PCT/JP2014/001568

§ 371 Date: Jun. 2, 2014

(30) Foreign Application Priority Data
Mar. 29, 2013 (JP) 2013-073835

(51) Int. Cl. G06Q 10/06; G06Q 40/00

(52) U.S. Cl. CPC G06Q 10/0639; G06Q 40/00
USPC 705/7.38

(57) ABSTRACT

The present invention provides a system that allows an income/expense status to be understood and a production track record to be understood, and that simplifies data input. Order recording part 2 allocates an order code to an order receipt quantity, a unit price, a customer and a delivery deadline of an order received by a sales unit that is one of in-house organizations to record in a recording part 6. Track record recording part 4 records in the recording part 6 a quantity and a selling monetary value of an intermediate product processed by each manufacturing unit that is an in-house organization and passed to another in-house organization. In this regard, the track record recording part 4 allocates the order code to the order receipt quantity, the unit price, the client and the delivery deadline of an order to specify which one of the received orders the order corresponds to, to record. In-house organization income/expense calculating part 8 calculates on an in-house organization basis an income and an expense of an in-house organization based on an in-house selling monetary value of an intermediate product that is processed by the in-house organization and passed to another in-house organization and an in-house buying monetary value of the intermediate production that is passed from the another in-house organization to the in-house organization. Further, the in-house organization income/expense calculating part 8 calculates an income and an expense on an order basis based on an order code upon calculation of the income and the expense on an in-house organization. Alternatively, the income and the expense are calculated on a customer basis based on the customer.

### TECHNICAL FIELD

The present invention relates to a business management device that allows for clear understanding of a management status.

### RELATED ART

Amoeba Management (trademark) is known as a business approach to managing profitability on a department basis (for example, JP-A-2009-187469). The Amoeba Management (trademark) is a business management system based on an idea that a company should not be managed by only top executives, but all employees of the company should be involved in management of the company. The business management system is designed to divide the whole company into small organizations as much as possible to clearly show results from their work in the respective organizations. This encourages all the employees to participate in the management of the company.

A feature of the Amoeba Management (trademark) is that small organizations called Amoeba (trademark) are established within a company to calculate incomes, expenses, a profit, and a profit per unit time on an Amoeba (trademark) basis, thus to provide timely business management information.

For example, in a case where a manufacturer produces products through a plurality of processes, organizations in charge of the respective processes are defined as Amoebas (trademark). Each Amoeba (trademark) in charge of one of the processes sells intermediate products to another Amoeba (trademark) in charge of the next process (hereinafter referred to as in-house buying and selling). A sales price of the intermediate product is recorded as sales. There have been some conventional management systems that calculate a monetary value in inter-process trade. However, in the conventional management systems, a sales price of the intermediate products supplied from one process to the next process is regarded as a manufacturing cost. In other words, there does not exist a concept that a profit is calculated in each process.

In contrast, the Amoeba Management (trademark) is constructed to generally determine a sales price for the in-house buying and selling by a negotiation between the Amoebas (trademark) in order to help the Amoebas (trademark) basically obtain a profit from the in-house buying and selling. This allows the respective Amoebas (trademark) to increase their profits as their work efficiency improves, and thus encourages employees, who belong to each of the Amoebas (trademark), to participate in the management of the company.

### SUMMARY OF THE INVENTION

### 1. Problems to be Solved by the Invention

As described above, the Amoeba Management (trademark) system is designed to establish small organizations called Amoeba (trademark) to specify incomes and expenses on an Amoeba (trademark) basis, and thus to boost morale of the employees who belong to each of the Amoebas (trademark).

However, the Amoeba Management (trademark) system can specify incomes and expenses on an Amoeba basis, but cannot calculate the incomes and expenses on an Amoeba basis and on an order basis or on a client basis. By learning the incomes and the expenses on an order basis or on a client basis, the Amoeba can learn the management status in more details.

Further, a progress status of a production plan on an Amoeba basis needs to be separately managed by a system for a production plan. Hence, a system that allows a production track record to be understood and, in addition, a system that allows an income/expense status to be understood need to be provided and each require data input that is also complicated.

An object of the present invention is to solve the foregoing problems and to provide a system that calculates an income and an expense on an Amoeba basis and on an order basis or on a client basis.

Further, another object of the present invention is to solve the foregoing problems and to provide a system that can allow an income/expense status to be understood and a production track record to be understood and simplify data input.

### 2. Means for Solving the Problem

(1) (2) A business management device according to the present invention is a business management device that can divide a company into a plurality of in-house organizations and calculate an income and an expense on an in-house organization basis, and that has: order recording means for receiving a quantity, a monetary value and a customer of an order received by a sales unit that is one of the in-house organizations, and allocating an order code to the quantity, the monetary value and the customer to record; track record recording means for recording together with the order code a quantity and a delivery monetary value of an intermediate product processed by a downstream manufacturing unit that is an in-house organization and passed to an upstream in-house organization; and in-house organization income/expense calculating means for calculating an income and an expense on an in-house organization basis based on an in-house selling monetary value that is a delivery monetary value of an intermediate product processed by the in-house organization and passed to another in-house organization and an in-house buying monetary value that is a delivery monetary value of an intermediate product passed from the another in-house organization to the in-house organization, and in which the in-house organization income/expense calculating means calculates the income and the expense of each in-house organization on a customer basis or on an order basis.

Consequently, it is possible to provide a device that allows an income/expense status to be understood on a customer basis or on an order basis by simple data input.

(3) The business management device according the present invention further has purchase recording means for associating a quantity and a purchase monetary value of a purchased goods purchased by a purchase unit that is one of the in-house organizations, with the order code to record.

Consequently, it is possible to understand the income/expense status also in consideration of purchased goods purchased from an outside.

(4) (5) The business management device according to the present invention is a business management device that can divide a company into a plurality of in-house organizations and calculate an income and an expense and a manufacture track record on an in-house organization basis, and that has: order recording means for receiving a quantity, a monetary value, a customer and a delivery deadline of an order received by a sales unit that is one of the in-house organizations, and allocating an order code to the quantity, the monetary value, the customer and the delivery deadline to record; in-house order placement recording means for associating with the order code a quantity, an in-house monetary value and an in-house delivery deadline of an in-house order placement made by an upstream manufacturing unit that is an in-house organization to a downstream manufacturing unit in response to an order to which the order code is allocated, to record; track record recording means for recording together with the order code a quantity and a delivery monetary value of an intermediate product processed by a downstream manufacturing unit that is an in-house organization and passed to an upstream in-house organization; in-house organization income/expense calculating means for calculating an income and an expense on an in-house organization basis based on an in-house selling monetary value that is a delivery monetary value of an intermediate product processed by the in-house organization and passed to another in-house organization and an in-house buying monetary value that is a delivery monetary value of an intermediate product passed from the another in-house organization to the in-house organization; and progress calculating means for calculating on the in-house organization basis a degree of progress of production based on the quantity of the intermediate product corresponding to each in-house order placement processed by the in-house organization.

Consequently, it is possible to achieve a device that allows an income/expense status to be understood and a production track record to be understood, while making data input easy.

The “order recording means” corresponds to the steps S9 and S12 in the embodiment.

The “track record recording means” corresponds to the step S15 in the embodiment.

The “progress calculating means” corresponds to the step S65 in the embodiment.

The scope of the definition of the “program” covers not only a program that can be directly executed by a CPU, but also a source form program, a compressed program, and an encrypted program.

### BRIEF DESCRIPTION OF DRAWINGS

FIG. 1 is a functional block diagram of a business management device according to one embodiment of the present invention.

FIG. 2 is a system diagram in a case where the business management device is a server device S.

FIG. 3 illustrates a hardware configuration of the server device S.

FIG. 4 shows a manufacturing process of a ceramic kitchen knife.

FIG. 5 is a flowchart of a business management program.

FIG. 6 is a flowchart of the business management program.

FIG. 7 is a flowchart of the business management program.

FIG. 8 shows a department code table.

FIG. 9 shows an example of an input screen.

FIG. 10 shows an example of order data.

FIG. 11 shows an example of an input screen.

FIG. 12 shows an example of in-house order data.

FIG. 13 shows an example of an input screen.

FIG. 14 shows an example of track record data.

FIG. 15 is a flowchart of the business management program.

FIG. 16 shows an example of extracted data.

FIG. 17 shows an example of income/expense data of a polishing department.

FIG. 18 is a flowchart of the business management program.

FIG. 19 shows an example of plan data of the polishing department.

FIG. 20 illustrates an example of progress data.

FIG. 21 is a view illustrating other manufacturing processes.

### DESCRIPTION OF THE PREFERRED EMBODIMENTS

### 1. Overview of System

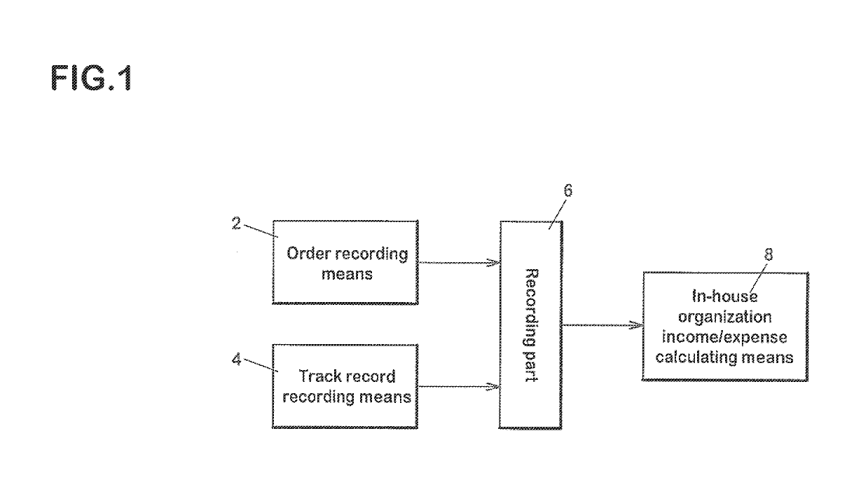

FIG. 1 is a function block diagram of a business management device according to one embodiment of the present invention. Order recording means 2 allocates an order code to a received order quantity, a unit price, a customer and a delivery deadline of an order received by a sales unit that is one of in-house organizations to record in a recording part 6. Track record recording means 4 records in the recording part 6 a quantity and a selling monetary value of an intermediate product processed by each manufacturing unit that is an in-house organization and passed to another in-house organization. In this regard, the track record recording means 4 associates a quantity and an in-house selling monetary value of the processed intermediate product with an order code to record in order to specify to which one of received orders the quantity and the in-house selling monetary value correspond.

In-house organization income/expense calculating means 8 calculates an income and an expense of in-house organizations on an in-house organization basis based on an in-house selling monetary value of the intermediate product processed by the in-house organization and passed to another in-house organization and an in-house buying monetary value of the intermediate product passed from another in-house organization to the in-house organization. Further, the in-house organization income/expense calculating means 8 calculates an income and an expense on an order basis based on the order code upon calculation of an income and an expense on an in-house organization basis. Alternatively, an income and an expense are calculated on a customer basis based on the customer.

As described above, the business management device according to the present embodiment specifies each order by allocating an order code to each order, and specifies an order code corresponding to an in-house buying and selling in each in-house organization. Consequently, it is possible to not only calculate an income and an expense on an in-house organization, but also calculate an income and an expense on an in-house organization basis and on an order basis or on an in-house organization and on a customer basis.

### 2. Hardware Configuration

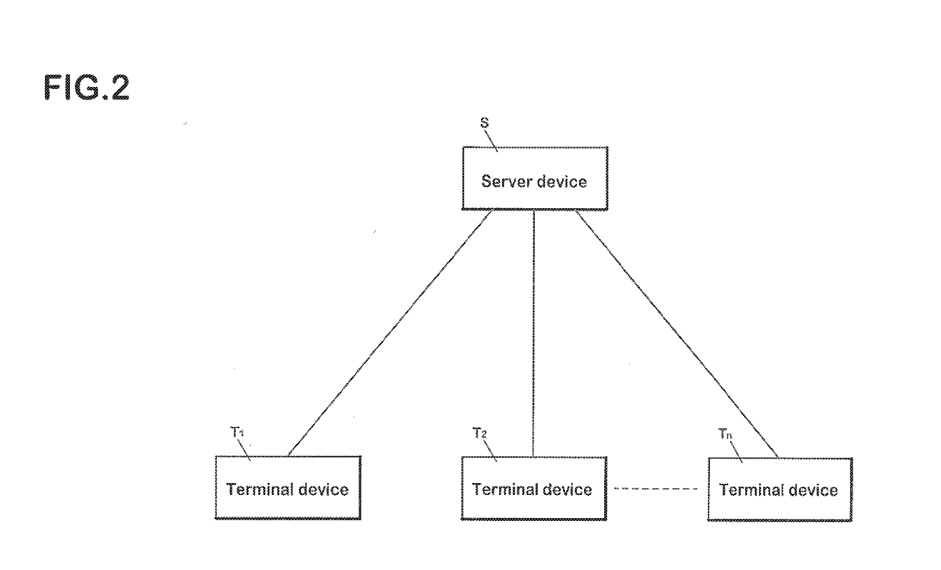

FIG. 2 illustrates a configuration of a business management system that is formed by constructing the business management device in FIG. 1 as a server device S. The server device S is connected with terminal devices T1, T2, . . . and Tn through a network. These terminal devices T1, T2, . . . and Tn are arranged in respective in-house organizations.

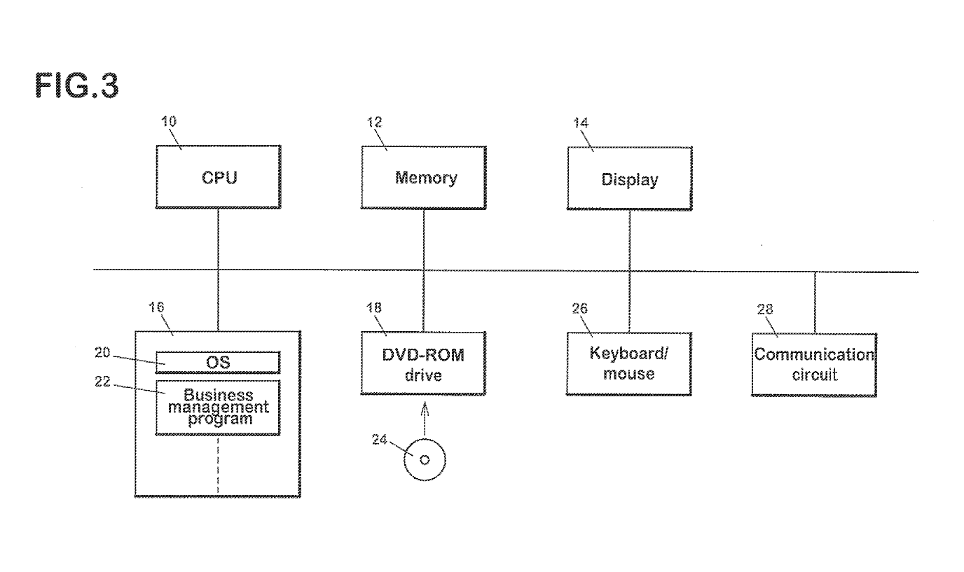

FIG. 3 illustrates a hardware configuration of the server device S. A CPU 10 is connected to a memory 12, a display 14, a hard disk 16, a DVD-ROM drive 18, a keyboard/mouse 26 and a communication circuit 28. An operating system 20 and a business management program 22 are recorded on the hard disk 16. The business management program 22 cooperates with the operating system 20 to fulfill its function. Further, the operating system 20 and the business management program 22 recorded together in the DVD-ROM 24 are installed in the hard disk 16 through the DVD-ROM drive 18. The communication circuit 28 is designed to connect to the network.

Hardware configurations of the terminal devices T1, T2, . . . and Tn are the same as that of the server device S. Meanwhile, a difference is that, instead of the business management program 22, a browser program is recorded on the hard disk 16.

### 3. Processing of Business Management Program

### (1) Overview

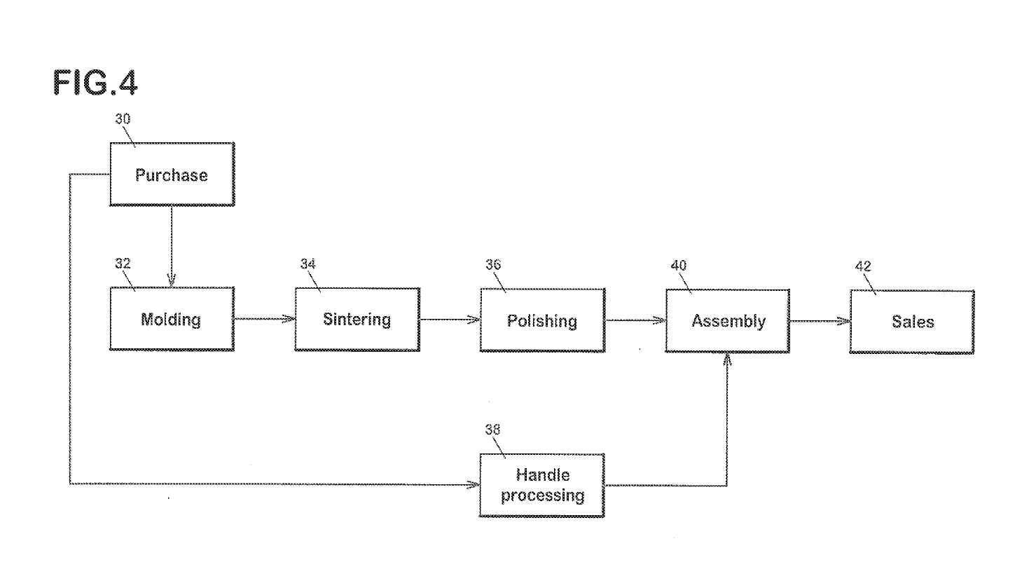

FIG. 4 shows an example of an in-house organization in a company that manufactures and sells ceramic kitchen knives. A sales department 42 obtains orders from clients. A purchase department 30 purchases materials (e.g. ceramic powders and handle materials) from an outside of the company. A molding department 32 receives delivery of the ceramic powders from the purchase department 30, molds the ceramic powders in a shape of a knife to obtain a molded ceramic. The molded ceramic is in-house sold to a sintering department 34. The sintering department 34 that in-house buys the molded ceramic sinters the molded ceramic, and processes the molded ceramic to a sintered ceramic. The sintered ceramic is in-house sold to a polishing department 36. The polishing department 36 that in-house buys the sintered ceramic polishes the sintered ceramic, and processes the sintered ceramic to a polished ceramic.

A handle process department 38 in-house purchases a handle material from the purchase department 30, and processes the handle material as a handle. The finished handle is in-house sold to an assembly department 40.

The assembly department 40 finishes a knife by assembling the polished ceramic that is in-house bought from the polishing department 36 and the handle that is in-house bought from the handle process department 38. The finished knife is delivered to a client through the sales department 42. The sales department 42 that in-house buys the knife from the assembly department 40 delivers the knife to the client.

### (2) Record of Order Data, in-House Order Data and Track Record Data

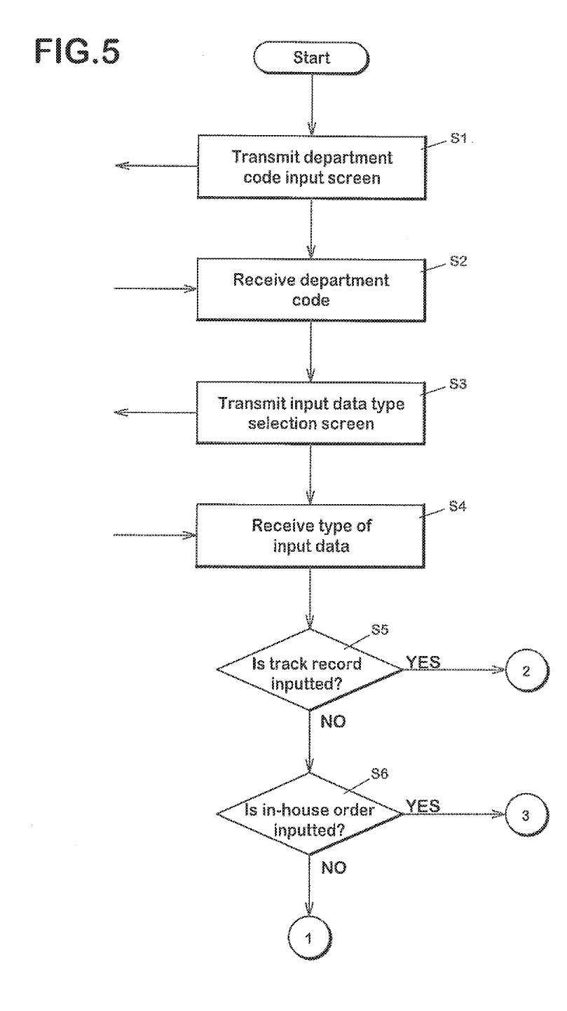

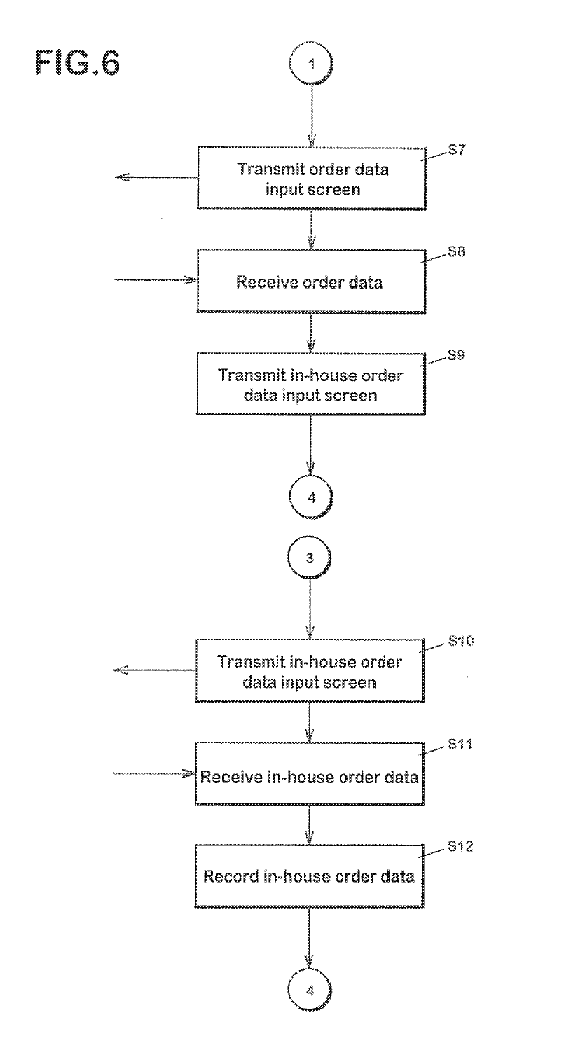

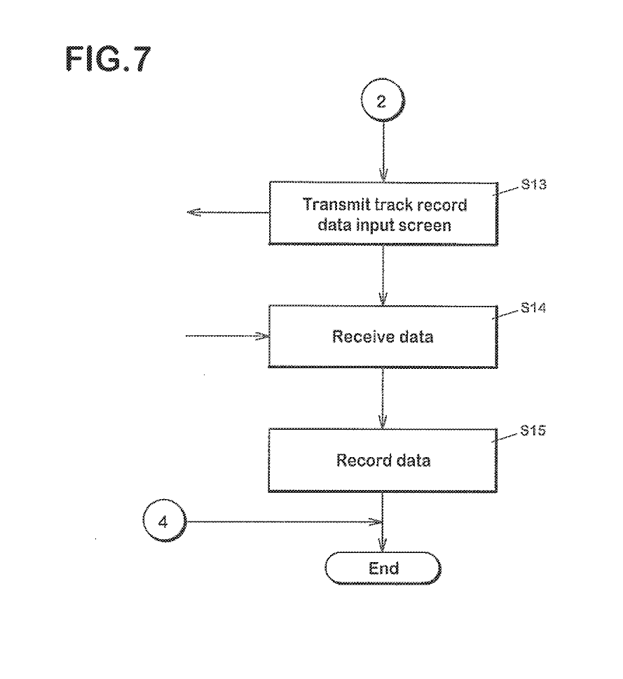

FIGS. 5 to 7 illustrate flowcharts corresponding to a processing part of data input of the business management program 22. First, an input of order data in a case where the sales department 42 obtains an order from a client will be described.

A user shows an intention to input data and accesses the server device S from the terminal device Ti of the sales department 42. In response to this access, the CPU 10 of the server device S transmits a department code input screen to the terminal device Ti (the step S1). The user of the sales department 42 inputs and transmits a department code from the terminal device Ti.

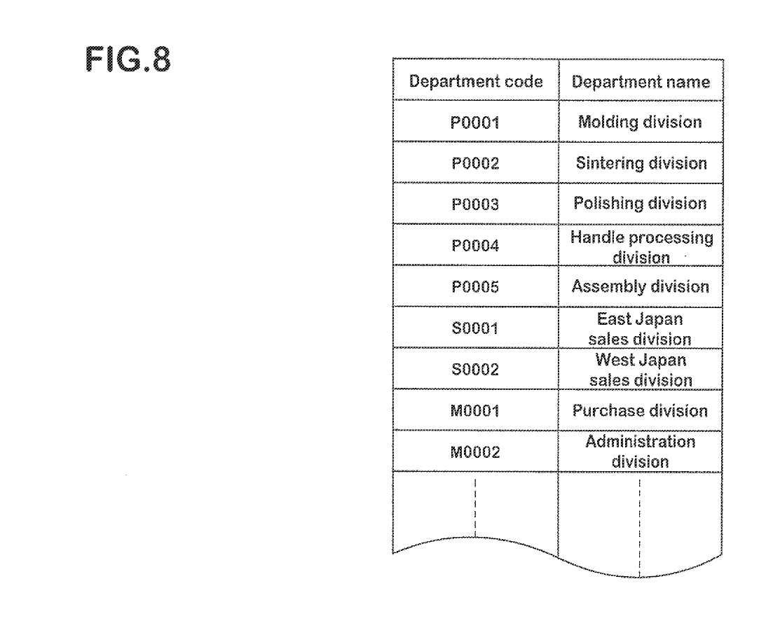

A department code table as illustrated in FIG. 8 is recorded on the hard disk 16 of the server device S. In addition, in the present embodiment, a plurality of sales departments (a west Japan sales division and an east Japan sales division) are provided. For example, a department code of the west Japan sales division is S0002. Thus, in this regard, the department code S0002 is inputted and transmitted. The CPU 10 of the server device S receives this department code (the step S2).

Next, the CPU 10 of the server device S transmits an input data type selection screen to the terminal device Ti (the step S3). A user of the west Japan sales division inputs and transmits a type of input data from the terminal device Ti. Since this system has data types consisting of order data, in-house order data and track record data, the user selects and transmits one of these data types. In this regard, the input of the order data is selected. The CPU 10 of the server device S receives the type of the input data (the step S4).

Next, the CPU 10 determines whether or not the type of the input data is track record data (the step S5). In this regard, the order data is inputted, and then the flow moves to a step S6. In the step S6, whether or not the type of the input data is in-house order data is determined. In this regard, the order data is inputted, and then the flow moves to a step S7.

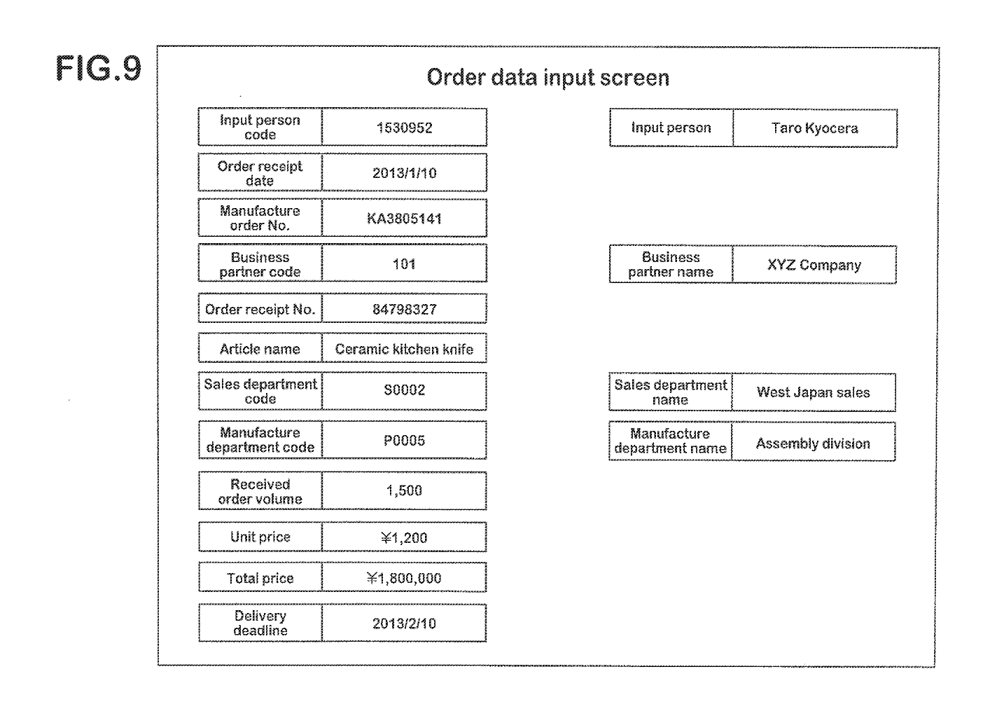

In the step S7, the CPU 10 transmits the order data input screen to the terminal device Ti. FIG. 9 illustrates an order data input screen. The user of the terminal device Ti inputs and transmits the order data by referring to this order data input screen. The order data includes items of an input person code, an input person, an order receipt date, a manufacture order No., a business partner code, a business partner name, an order receipt No., an article name, a sales department code, a sales department name, a manufacture department code, a manufacture department name, a received order volume, a unit price, a monetary value, a delivery deadline and a delivery volume.

When a sales department code is inputted, a sales department name is automatically displayed according to a correspondence table recorded on the hard disk 16.

The business partner code and the business partner name are items for specifying a client. An input is inputted in the same way as the sales department code and the sales department name. The input person code and the input person are items for specifying the input person. The input is inputted in the same way as the sales department code and the sales department name.

The manufacture department code and the manufacture department name are items for specifying a manufacture department of a destination (an order placement destination) that places a manufacture order of the received order goods. The input is inputted in the same way as the sales department code and the sales department name. In the present embodiment, a manufacture order to an in-house manufacture department (an order placement source) is simultaneously inputted in the screen in which the sales department inputs a received order. In the present embodiment, the manufacture order is for the assembly department 40 (an assembly division).

The received order volume, the unit price and the monetary value are the quantity, the unit price and the monetary value of received orders. In the present embodiment, the delivery deadline for a client is a delivery deadline for an in-house manufacture department (the order placement destination).

In addition, the order receipt No. and the manufacture order No. are automatically generated by the CPU 10. The order receipt No. is a code for specifying order receipt, and the manufacture order No. is a code for specifying order placement to the manufacture department (the order placement destination).

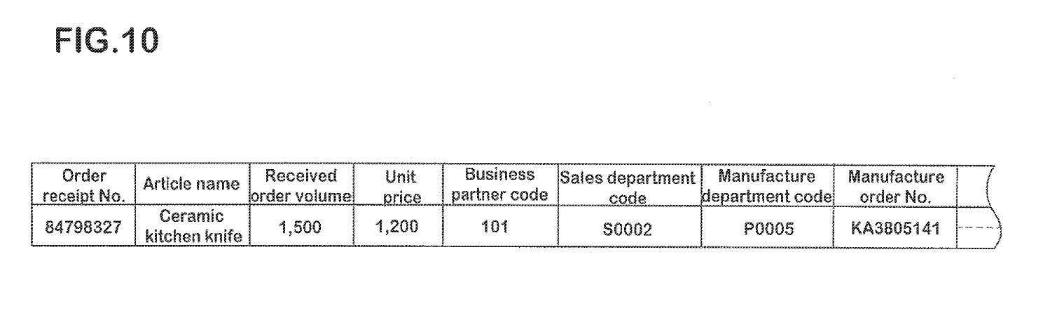

The CPU 10 of the server device S receives order data (the step S8). Further, the CPU 10 records this order data on the hard disk 16 (the step S9). FIG. 10 illustrates an example of recorded order data. As described above, order receipt of the sales department and the manufacture order to the in-house manufacture department are recorded. In addition, as is clear from FIG. 10, the order receipt No. and the manufacture order No. are associated.

Next, processing whereby the assembly department 40 (the assembly division) places an in-house order to the polishing department 36 (a polishing division) that is a previous process based on the above order will be described. In this regard, the assembly division 40 is the order placement source, and the polishing department is the order placement destination.

The user accesses the server device S from the terminal device Ti of the assembly department 40. Here, the terminal device Ti is provided on a department basis or on an input person basis, and i can be a different number depending on a department and an input person. In response to this access, the CPU 10 of the server device S transmits the department code input screen to the terminal device Ti of the assembly department 40 (the step S1). The user of the assembly department 40 inputs and transmits a department code from the terminal device Ti. The CPU 10 of the server device S receives the department code (the step S2). Here, a department code P0005 is inputted and transmitted. The CPU 10 of the server device S receives this department code (the step S2).

Next, the CPU 10 of the server device S transmits the input data type selection screen to the terminal device Ti (the step S3). The user of the assembly department 40 inputs and transmits a type of input data from the terminal device Ti. In this regard, the user also inputs and transmits a manufacture order No. that is a processing target from the terminal device Ti.

Here, an in-house order is inputted, and then in-house order data is selected. The CPU 10 of the server device S receives the type of this input data (the step S4).

Next, the CPU 10 determines whether or not the type of the input data is track record data (the step S5). Here, the in-house order data is inputted, and then the flow moves to the step S6. In the step S6, whether or not the type of the input data is in-house order data is determined. Here, the in-house order data is inputted, and then the flow moves to the step S10.

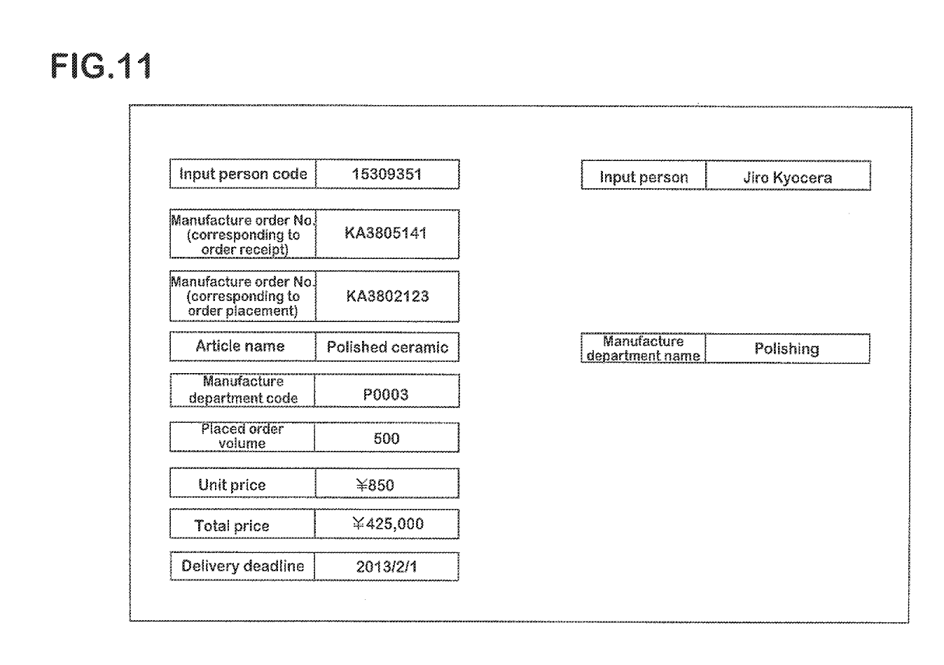

In the step S10, the CPU 10 transmits an order data input screen corresponding to the transmitted manufacture order No., to the terminal device Ti. FIG. 11 illustrates an in-house order data input screen. The user of the terminal device Ti inputs and transmits in-house order data by referring to this in-house order data input screen. The in-house order data includes items of an article name, a placed order volume, a manufacture department code indicating a manufacture department of an order placement destination, and a delivery deadline.

In the present embodiment, when a manufacture order No. (corresponding to order receipt) from the sales department or a subsequent process, a manufacture order is designed to be issued to the in-house order placement destination (a previous process). A code different from that of the manufacture order No. corresponding to the order receipt is automatically assigned to the manufacture order No. (corresponding to order placement), and the two manufacture orders No. are associated.

Different manufacture orders No. are allocated on an in-house order placement basis in this way since management becomes easy in the following case. For example, it is assumed that the in-house order placement (referred to as a manufacture order No. B) is placed to the assembly department 40 based on the order (an order receipt No. A) received by the sales department 42. Further, it is assumed that the in-house order placement (a manufacture order No. D) is made to the assembly department 40 based on another order (an order receipt No. C) received by the sales department 42. Thus, when the assembly department 40 collectively makes in-house order placement of in-house order receipts based on the manufacture orders No. C and D to the polishing department, numbering a manufacture order No. E different from the manufacture orders No. C and D has a meaning. In this regard, the manufacture order No. E is associated with the manufacture orders No. C and D.

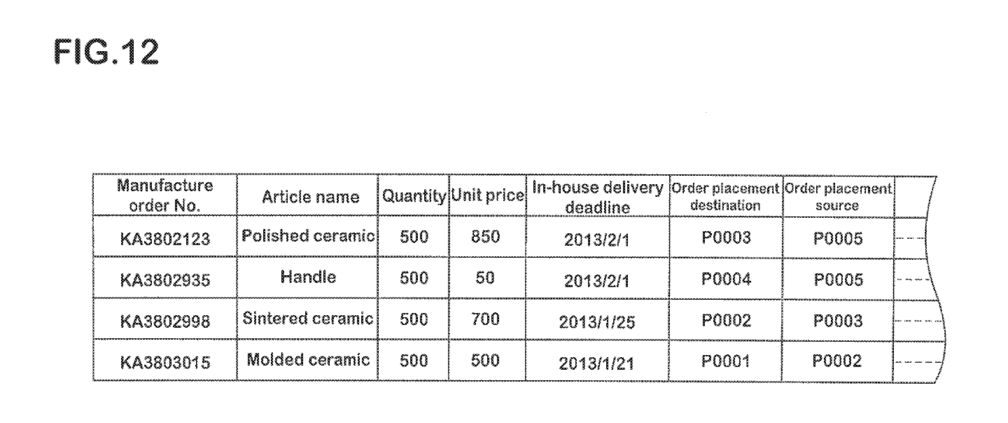

The CPU 10 of the server device S receives the in-house order data (the step S11). Further, the CPU 10 records this in-house order data on the hard disk 16 (the step S12). FIG. 12 illustrates an example of the recorded in-house order data. As described above, the in-house order data is recorded.

In addition, the sintering department 34, the molding department 32 and the handle process department 38 input and register in-house order data likewise. By this means, for example, data as illustrated in FIG. 12 is recorded.

In the present embodiment, each department places an in-house order to a department of a previous process, and determines an in-house delivery deadline. Each department makes a manufacturing plan based on this in-house delivery deadline, and records the manufacturing plan in the server device S.

### (3) Record of Track Record Data

Next, a case where each department inputs a processing track record will be described. First, track record input in a case where the polishing department 36 (the polishing division) manufactures a polished ceramic based on the in-house order data (the second row) in FIG. 12 will be described.

The user accesses the server device S from the terminal device Ti of the polishing department 36. In response to this access, the CPU 10 of the server device S transmits a department code input screen to the terminal device Ti (the step S1). The user of the polishing department 36 inputs and transmits a department code from the terminal device Ti. Here, a department code P0003 of the polishing department 36 is transmitted. The CPU 10 of the server device S receives the department code (the step S2).

Next, the CPU 10 of the server device S transmits the input data type selection screen to the terminal device Ti (the step S3). The user of the polishing department 36 inputs and transmits a type of input data and a manufacture order No. from the terminal device Ti. Here, input of track record data is selected. The CPU 10 of the server device S receives the type of this input data (the step S4).

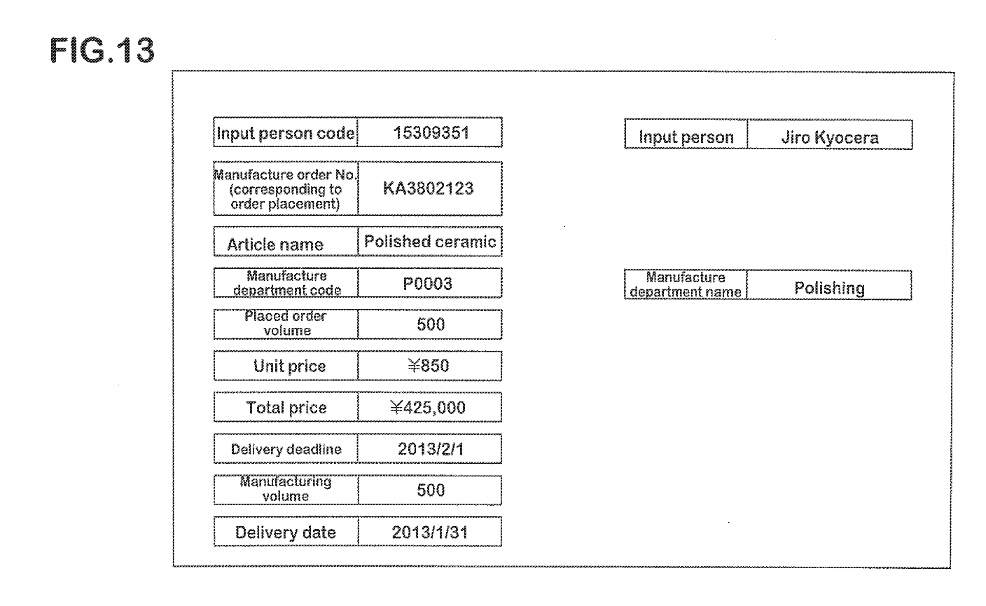

The CPU 10 of the server device S determines whether or not track record data is inputted (the step S5). Here, the track record data is inputted, and then the flow moves to the step S13. In the step S13, the CPU 10 transmits a track record data input screen corresponding to the inputted manufacture order No., to the terminal device Ti. FIG. 13 illustrates the track record data input screen. In the present embodiment, the track record data input screen displays a screen in which entry fields of a manufacturing volume and a delivery date are added to the in-house order data input screen.

The user of the terminal device Ti inputs and transmits a track record (a manufacturing volume and a delivery date) corresponding to the in-house order data by referring to this track record data input screen.

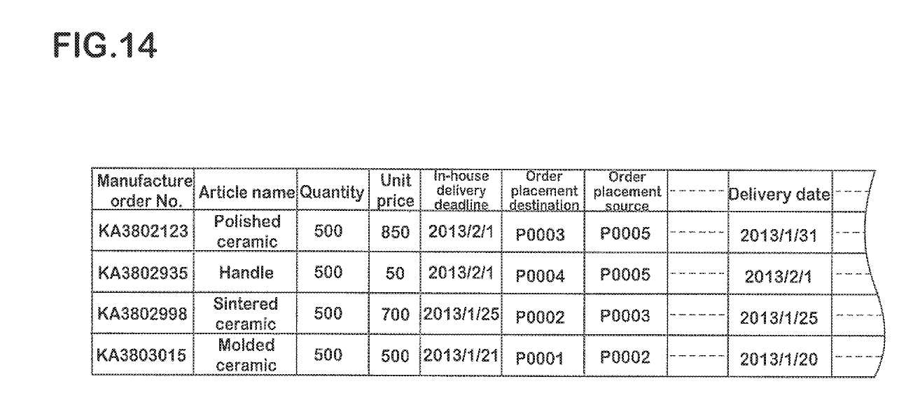

The CPU 10 of the server device S receives track record data (the step S14). Further, the CPU 10 records this track record data on the hard disk (the step S15). FIG. 14 illustrates an example of track record data. In the present embodiment, track record data such as the manufacturing volume and the delivery date are added to the in-house order data in FIG. 12 and recorded.

Similar to the above, the molding department 32, the sintering department 34, the handle process department 38 and the assembly department 40 input track record data from the respective terminal devices Ti. As a result, the track record data as illustrated in FIG. 14 is recorded on the hard disk 16.

### (4) Calculation of Income and Expense on a Department Basis

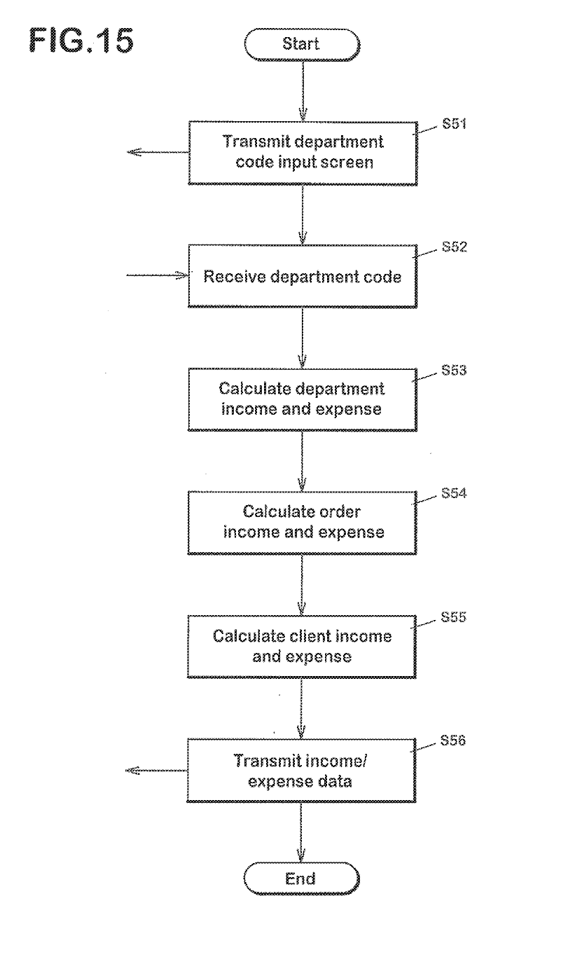

Next, processing of calculating an income and an expense on a department basis will be described. FIG. 15 illustrates a flowchart corresponding to a calculation part of an income and an expense of the business management program 22. Here, for example, processing of calculating an income and an expense of the polishing department 36 will be described.

The user shows an intention to calculate the income and the expense and accesses the server device S from the terminal device Ti of the polishing department 36. In response to this access, the CPU 10 of the server device S transmits a department code input screen to the terminal device Ti (the step S51). The user of the polishing department 36 inputs and transmits a department code from the terminal device Ti. Here, the department code P0003 is inputted and transmitted. The CPU 10 of the server device S receives this department code (the step S52).

The CPU 10 of the server device S calculates the income and the expense based on track record data of the polishing department (the step S53). First, the CPU 10 extracts data whose order placement destination or order placement source is the polishing department (the department code P0003) from the track record data.

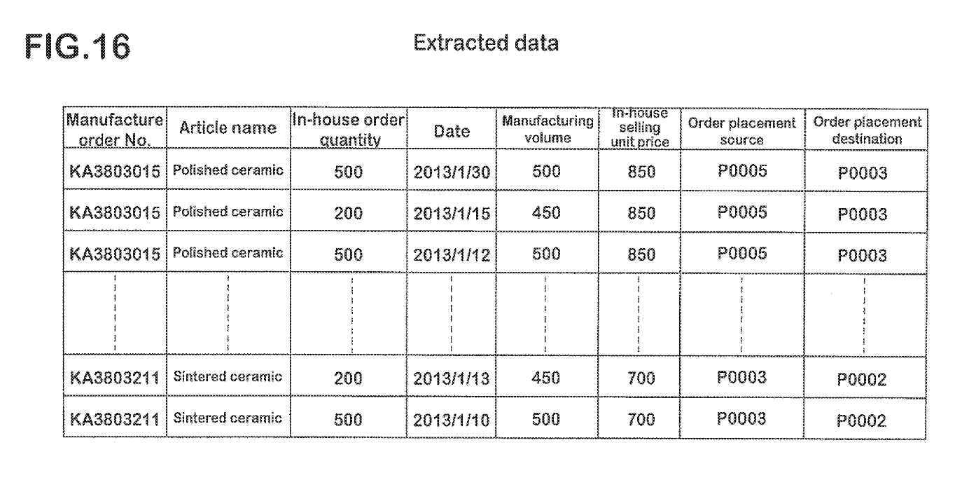

FIG. 16 illustrates an example of extracted data. The CPU 10 calculates the income of the polishing department based on data (data of in-house selling from the polishing department) whose order placement destination is described as the polishing department 36 (the department code P0003). More specifically, for the data, the manufacturing volume and an in-house selling unit price are multiplied and summed up. Further, the expense of the polishing department is calculated based on data (data of in-house buying by the polishing department) whose order placement source is described as the polishing department 36 (the department code P0003). More specifically, for the data, the manufacturing volume and the in-house selling unit price are multiplied and summed up. Further, an electricity bill distributed to each department according to the number of people is calculated as an allocated expense.

As described above, the income and the expense of the polishing department are calculated by subtracting the expense from the income of a target department (the polishing department in this case). Consequently, it is possible to calculate the income and the expense on a department basis.

Next, the CPU 10 calculates an income and an expense of an order (the step S54). That is, the CPU 10 calculates the income and the expense on an order of the polishing department basis instead of the incomes and the expenses of the entire polishing department. First, extracted data of the polishing department in FIG. 16 is compiled on an order code basis. First, the income of the order is calculated by compiling data (data of in-house selling by the polishing department) whose order placement destination is described as the polishing department 36 (the department code P0003) based on data to which the same order code is allocated. Further, the expense of the order is calculated by compiling data (data of in-house buying by the polishing department) whose order placement source is described as the polishing department 36 (the department code P0003) based on data to which the same order code is allocated.

Furthermore, the order allocated expense is calculated by allocating the allocated expense of the polishing department at a ratio of the order with respect to the order of the entire extracted data in FIG. 16. More specifically, this ratio can be determined based on an order quantity, a monetary value and working hours. As described above, the income and the expense are calculated on an order of the department basis by subtracting the expense and the allocated expense of the order from the income of each order of the target department (the polishing department in this case). Consequently, it is possible to calculate the income and the expense on a department basis and on an order basis.

Next, the CPU 10 calculates a client income and expense (the step S55). That is, the CPU 10 calculates the income and the expense on a client of the polishing department basis instead of the incomes and the expenses of the entire polishing department. First, the extracted data of the polishing department in FIG. 16 is compiled on a client basis.

The income from the client is calculated by extracting data (data of in-house selling from the polishing department) whose order placement destination is described as the polishing department 36 (the department code P0003), extracting data corresponding to the orders of the same client from the data and adding up the monetary value. Further, cost of in-house buying related to orders from the client is calculated by extracting data (data of in-house buying by the department) whose order placement source is described as the polishing department 36 (the department code P0003), further extracting data corresponding to orders of the same client from the data and adding up the monetary value.

In addition, the data corresponding to the orders of the same client is extracted by tracking from an order placement destination to an order placement source using a manufacture order No. of in-house buying and selling as a key, reaching the last order receipt No. of the sales department and checking that the order data illustrated in FIG. 10 has a common business partner code.

Further, a client allocated expense is calculated by allocating the allocated expense of the polishing department at a ratio of an order quantity of the client with respect to the order quantity of the entire extracted data in FIG. 16. As described above, the income and the expense are calculated on a client of the department basis by subtracting the expense from the income of a client of a target department (the polishing department in this case) basis. Consequently, it is possible to calculate the income and the expense on a department basis and on a client basis. Consequently, each department can determine which client business operation is prioritized.

The Amoeba Management (trademark) allows each Amoeba that is a minimum management unit to increase the sales and take means for saving the expense. When the above information of the income and the expense on an order basis or on a client basis can be obtained as information based on which the determination is made in addition to a sum of incomes and expenses of Amoebas, management can be performed by predicting an effect of various activities such as in-house buying and selling and price negotiation of purchase of raw materials using these pieces of information.

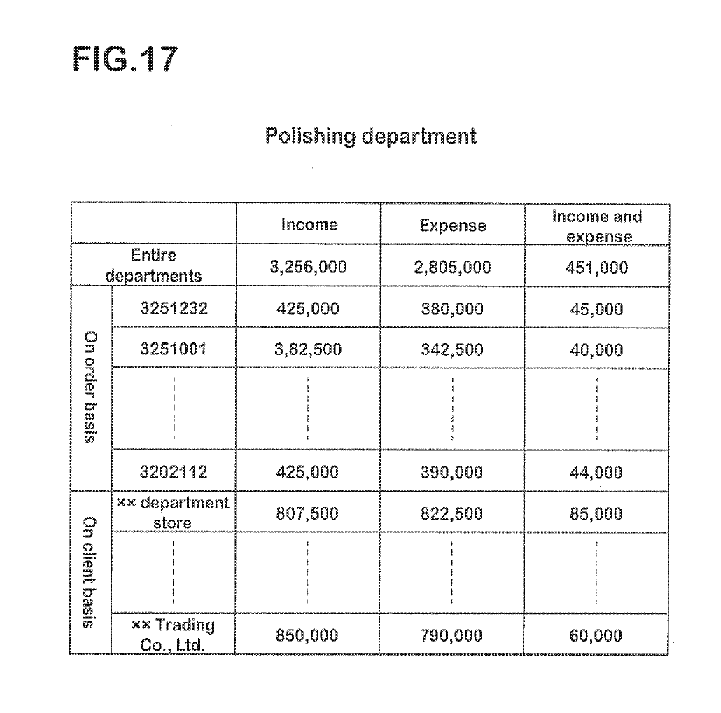

The CPU 10 transmits income/expense data calculated as described above, to the terminal device Ti (the step S56). FIG. 17 illustrates an example of income/expense data of the polishing department.

### (5) Production Progress Check on a Department Basis

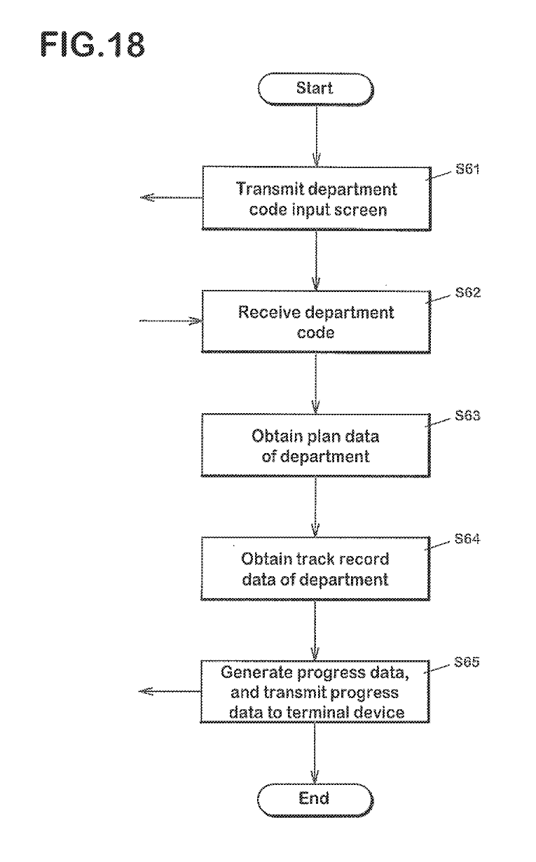

Next, production progress check processing on a department basis will be described. FIG. 18 illustrates a flowchart corresponding to production progress check part of the business management program 22. Hereinafter, for example, processing of checking a production progress of the polishing department 36 will be described.

The user shows an intention to check the production progress and access the server device S from the terminal device Ti of the polishing department 36. In response to this access, the CPU 10 of the server device S transmits a department code input screen to the terminal device Ti (the step S61). The user of the polishing department 36 inputs and transmits a department code from the terminal device Ti. In this regard, the department code P0003 is inputted and transmitted. The CPU 10 of the server device S receives this department code (the step S62).

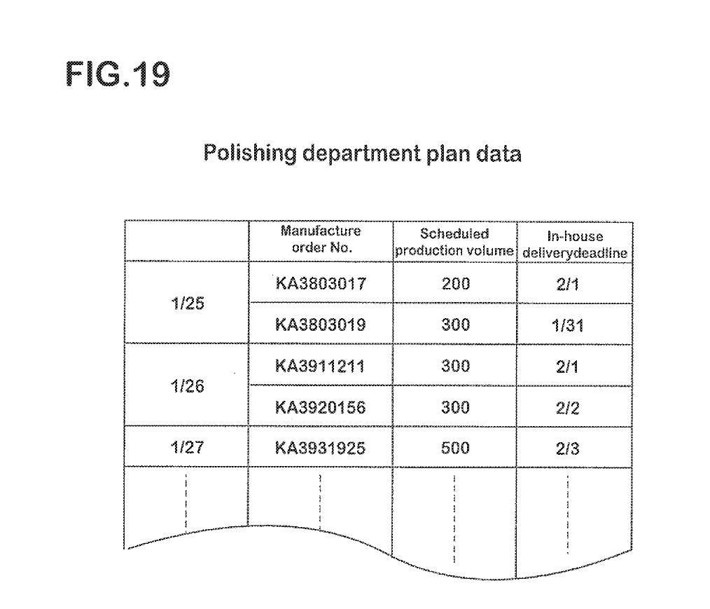

The CPU 10 obtains plan data of the polishing department 36 from the hard disk 16 (the step S63). Each department makes a production plan based on an in-house delivery deadline indicated by in-house order data to make this plan data. FIG. 19 illustrates plan data of the polishing department. A scheduled production volume and an in-house delivery deadline of each day are indicated in association with an order. For example, 200 of a manufacture order No. “KA3803017” and 300 of “KA3803019” are a production plan on January 25.

Next, the CPU 10 obtains track record data corresponding to the plan data of the polishing department 36 (the step S64). The corresponding track record data can be obtained based on an order code.

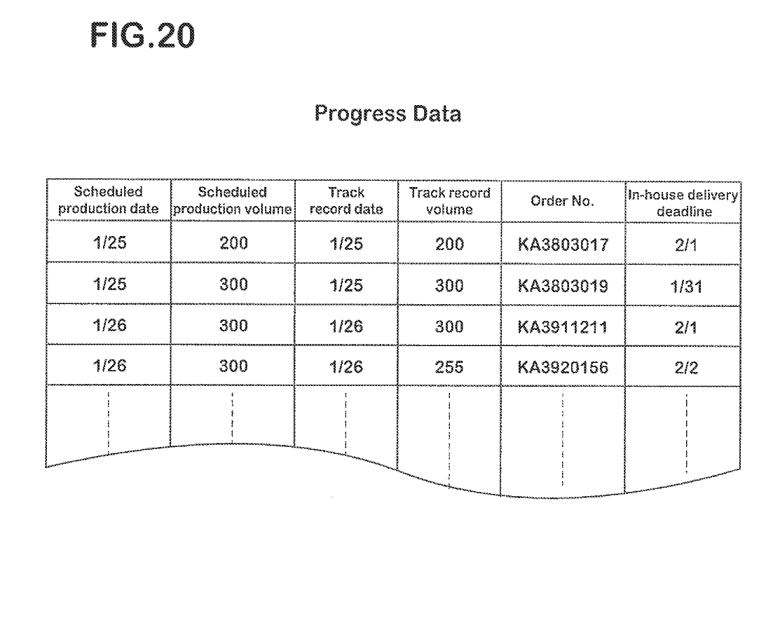

Subsequently, the CPU 10 associates the plan data and the track record data, generates progress data and transmits the progress data to the terminal device Ti (the step S65). FIG. 20 illustrates an example of the generated progress data. The user of the terminal device Ti can check whether or not the production proceeds as planed in view of this progress data. For example, in FIG. 20, although a production schedule of the order code “KA3920156” on January 26 was 300 polished ceramics, 255 polished ceramics were produced.

In the present embodiment, order data, in-house order data and track record data are associated according to the order code. Consequently, it is possible to not only calculate an income and an expense on a department basis but also generate a progress status of a plan without preparing an additional system.

### 4. Other Embodiment

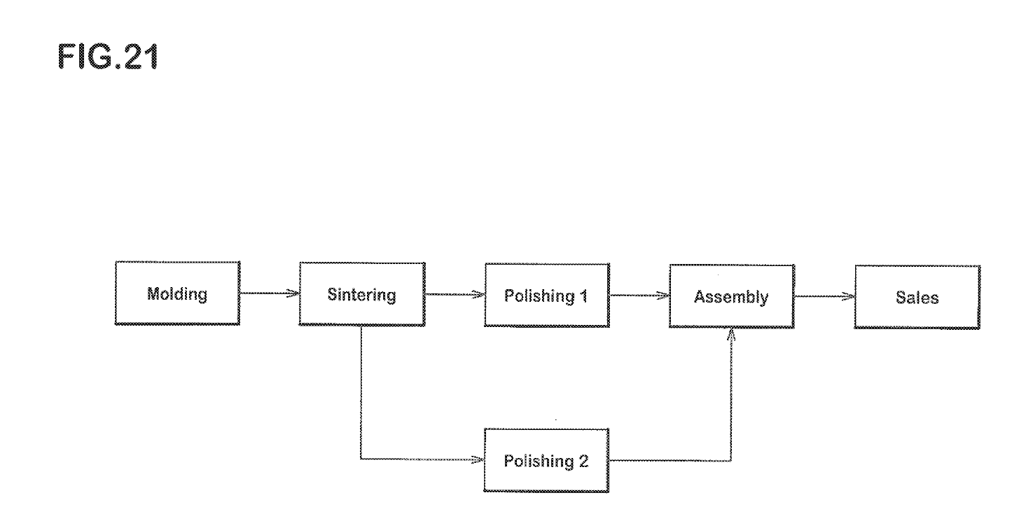

(1) One product finished according to the process as illustrated in FIG. 4 has been described as an example in the above embodiment. However, the present invention may also be applied to a case where each department processes a plurality of goods. Further, as illustrated in FIG. 21, the present invention may also be applied to a case where there are processes (a polishing department 1 and a polishing department 2) of performing the same processing. In this case, the present invention may also be applied to a case where in-house selling prices are different between the polishing department 1 and the polishing department 2.

(2) Not only the income and the expense may be calculated but also the progress may be managed in the above embodiment. However, one of calculation and management may be performed.

(3) The business management device is constructed as the server device S and allows accesses from terminal devices in the above embodiment. However, the business management device may be constructed a standalone device (one PC).

(4) An order receipt NO. and a manufacture order No. of each department are associated and recorded in the above embodiment. However, order receipts No. may also be used in all departments.

(5) In addition, goods are collectively delivered in response to orders from clients in the above embodiment. However, goods may be delivered partially a plurality of times. For example, in FIG. 9, a delivery deadline may be set to deliver 500 on Feb. 10, 2013, 900 on Mar. 28, 2013 and 100 on Apr. 11, 2013. Similarly, goods may be partially delivered in response to a manufacture order similar to the above.

1. A business management device that can divide a company into a plurality of in-house organizations and calculate an income and an expense on an in-house organization basis, the business management device comprising:
order recording means for receiving a quantity, a monetary value and a customer of an order received by a sales unit that is one of the in-house organizations, and allocating an order code to the quantity, the monetary value and the customer to record;
track record recording means for recording together with the order code a quantity and a delivery monetary value of an intermediate product processed by a previous manufacturing unit that is an in-house organization and passed to a subsequent in-house organization; and
in-house organization income/expense calculating means for calculating an income and an expense on an in-house organization basis based on an in-house selling monetary value that is a delivery monetary value of an intermediate product processed by the in-house organization and passed to another in-house organization and an in-house buying monetary value that is a delivery monetary value of an intermediate product passed from the another in-house organization to the in-house organization, wherein
the in-house organization income/expense calculating means calculates the income and the expense of each in-house organization on a customer basis or on an order basis.

2. A business management program for causing a computer to function as a business management device, the business management program causing the computer to function as:
order recording means for receiving a quantity, a monetary value and a customer of an order received by a sales unit that is one of the in-house organizations, and allocating an order code to the quantity, the monetary value and the customer to record;
track record recording means for recording together with the order code a quantity and a delivery monetary value of an intermediate product processed by a previous manufacturing unit that is an in-house organization and passed to a subsequent in-house organization; and
in-house organization income/expense calculating means for calculating an income and an expense on an in-house organization basis based on an in-house selling monetary value that is a delivery monetary value of an intermediate product processed by the in-house organization and passed to another in-house organization and an in-house buying monetary value that is a delivery monetary value of an intermediate product passed from the another in-house organization to the in-house organization, wherein
the in-house organization income/expense calculating means calculates the income and the expense of each in-house organization on a customer basis or on an order basis.

3. The business management device according to claim 1, further comprising purchase recording means for associating a quantity and a purchase monetary value of a purchased goods purchased by a purchase unit that is one of the in-house organizations, with the order code to record.

4. A business management device that can divide a company into a plurality of in-house organizations and calculate an income and an expense and a manufacture track record on an in-house organization basis, the business management device comprising:
order recording means for receiving a quantity, a monetary value, a customer and a delivery deadline of an order received by a sales unit that is one of the in-house organizations, and allocating an order code to the quantity, the monetary value, the customer and the delivery deadline to record;
in-house order placement recording means for associating with the order code a quantity, an in-house monetary value and an in-house delivery deadline of an in-house order placement made by a subsequent manufacturing unit that is an in-house organization to a previous manufacturing unit in response to an order to which the order code is allocated, to record;
track record recording means for recording together with the order code a quantity and a delivery monetary value of an intermediate product processed by a previous manufacturing unit that is an in-house organization and passed to a subsequent in-house organization;
in-house organization income/expense calculating means for calculating an income and an expense on an in-house organization basis based on an in-house selling monetary value that is a delivery monetary value of an intermediate product processed by the in-house organization and passed to another in-house organization and an in-house buying monetary value that is a delivery monetary value of an intermediate product passed from the another in-house organization to the in-house organization; and
progress calculating means for calculating on the in-house organization basis a degree of progress of production based on the quantity of the intermediate product corresponding to each in-house order placement processed by the in-house organization.

5. A business management program for causing a computer to function as a business management device, the business management program causing the computer to function as:
order recording means for receiving a quantity, a monetary value, a customer and a delivery deadline of an order received by a sales unit that is one of the in-house organizations, and allocating an order code to the quantity, the monetary value, the customer and the delivery deadline to record;
in-house order placement recording means for associating with the order code a quantity, an in-house monetary value and an in-house delivery deadline of an in-house order placement made by a subsequent manufacturing unit that is an in-house organization to a previous manufacturing unit in response to an order to which the order code is allocated, to record;
track record recording means for recording together with the order code a quantity and a delivery monetary value of an intermediate product processed by a previous manufacturing unit that is an in-house organization and passed to a subsequent in-house organization;
in-house organization income/expense calculating means for calculating an income and an expense on an in-house organization basis based on an in-house selling monetary value that is a delivery monetary value of an intermediate product processed by the in-house organization and passed to another in-house organization and an in-house buying monetary value that is a delivery monetary value of an intermediate product passed from the another in-house organization to the in-house organization; and
progress calculating means for calculating on the in-house organization basis a degree of progress of production based on the quantity of the intermediate product corresponding to each in-house order placement processed by the in-house organization.

6. The business management program according to claim 2, further comprising purchase recording means for associating a quantity and a purchase monetary value of a purchased goods purchased by a purchase unit that is one of the in-house organizations, with the order code to record.
